(19) United States
(12) Patent Application Publication
(10) Pub. No.: US 2014/0373674 A1
(43) Pub. Date: Dec. 25, 2014

(54) MACHINE PROTECTION DEVICE

(71) Applicant: KRONES AG, Neutraubling (DE)

(72) Inventors: Christian Stoiber, Michelsneukirchen (DE); Robert Scheibenpflug, Pfatter (DE)

(21) Appl. No.: 14/302,062

(22) Filed: Jun. 11, 2014

(30) Foreign Application Priority Data
Jun. 25, 2013 (DE) 102013212125.3

(51) Int. Cl. F16P 3/08

(52) U.S. Cl. CPC F16P 3/08
USPC 74/612

(57) ABSTRACT

A protection mechanism for a machine, used for monitoring and securing the position of doors and/or positionable machine parts, having a central safety bracket movably supported relative to the doors and/or the positionable machine parts, and configured such that it can only be closed when all the doors are closed and all the machine parts are at an operating position, and a central safety switch which monitors the position of the central safety bracket.

### CROSS-REFERENCE TO RELATED APPLICATION

The present application claims priority to German Application No.102013212125.3, filed Jun. 25, 2013. The priority application, DE 102013212125.3, is hereby incorporated by reference.

### FIELD OF THE DISCLOSURE

The present invention relates to a protection mechanism for a machine, in particular, a protection mechanism for a machine used for monitoring and securing the position of doors and/or positionable machine parts so as to prevent a collision of objects and/or persons with moving or rotating machine parts. The present invention also relates to a protection mechanism for a labeler and a cold-glue unit.

### BACKGROUND

Machines for handling objects, such as containers or bottles, comprise fast rotating and moving components, which must be protected against contact so as to avoid malfunctions, accidents and injuries of persons. Normally, such machines are provided with a housing, which also provides protection against collisions. Since such machines must, however, be serviced, closable openings and inlets to the housing are provided, which represent a safety risk. Normally, each of the inlets is monitored separately by a suitable sensor system and locked by a locking mechanism, said sensor system and locking mechanism guaranteeing that the housing can only be opened when the machine is out of operation. Alternatively, the sensor system may also cause the machine to come to a standstill when the housing is opened. Such machines normally have a plurality of openings and/or doors, which all necessitate monitoring to guarantee safe operation.

Exemplarily, European patent application EP-A-2345835 shows a locking and securing device for a working area of a machine. This prior art shows in particular two pivotable flaps or doors in a frame or housing, which serve as a movable protection device e.g. for bottle treatment and processing facilities, such as a labeler for applying labels to bottles or containers, so as to allow access to the machine for servicing, cleaning or maintenance work. In order to guarantee safety, each door is provided with a locking mechanism and a monitoring unit. The monitoring unit guarantees that the moving parts of the machine will be stopped when the door opens. The locking mechanism guarantees that the door will be mechanically unlocked slowly enough for the machine to be at rest when the door is open. Due to the delay occurring when the door is opened by hand, the rotating and moving machine parts can be brought to a standstill gently and, consequently, with little wear.

These protection devices are disadvantageous insofar as each protection door must be provided with a separate lock switch and the electronics required therefor, whereby the required amount of mechanical and electronic components and wirings is increased.

### SUMMARY OF THE DISCLOSURE

It is therefore a general object of the present disclosure to provide, with little mechanical and electrical expenditure, a protection device for machines comprising a plurality of doors, which effectively prevents contact with rotating and moving machine parts and allows gentle stopping of the moving parts.

More specifically, the object of the present disclosure is to be seen in the provision of a protection mechanism for a cold-glue unit, which monitors and secures not only the position of doors but also the position of a vertically adjustable drive motor for the gluing roller.

The general object of the present disclosure is achieved by a protection mechanism for a machine, used for monitoring and securing the position of a plurality of doors and/or positionable machine parts. The protection mechanism is characterized by a central safety bracket, which is movably supported relative to the doors and the positionable machine parts and configured such that it can only be closed when all the doors are closed and all the machine parts are at an operating position. In addition, the protection mechanism is characterized by a central safety switch, which monitors the position of the central safety bracket. It is therefore not necessary to secure and monitor each individual door by a separate safety switch and a separate locking mechanism. In addition, the central safety bracket must have sufficiently large dimensions to cover all the doors so that actuating the safety bracket will take one to two seconds, which will suffice to gently stop the moving machine parts before the doors can be opened and the positionable machine parts moved.

As used herein, “doors” refer to pivotable flaps allowing access to safety-relevant areas of the machine, which entail a risk of accidents or injuries due to fast rotating or moving machine parts.

According to an embodiment, the central safety bracket is configured such that it is able to assume two end positions for the machine conditions open and closed. In order to increase the operational safety and facilitate handling, the central safety bracket may be fixed at the two end positions by means of a gas spring.

According to an embodiment, the central safety bracket is configured such that, with the door open, it is blocked and cannot be moved to the closed end position. The central safety switch, which monitors the position of the central safety bracket, will thus be prevented from reporting a closed, i.e. ready-to-operate condition, although a door is still open.

According to an embodiment, the central safety bracket is configured such that the doors are blocked, when the central safety bracket is at the closed end position. That is, as long as the central safety switch indicates a closed, i.e. ready-to-operate position, it will not be possible to open a door.

According to another embodiment, the central safety switch is configured such that, when actuated by an operating element for the central safety switch, it allows the machine to operate, and, when not actuated, it blocks operation of the machine. This safety measure guarantees that operation of the machine cannot be started until all the elements occupy their operating position, since the central safety switch is normally open and can only be closed when all the components monitored, i.e. doors and machine parts as well as the safety bracket, are in their operating position.

According to an embodiment, the central safety switch is attached to the central safety bracket. This is of advantage when the operating element of the central safety switch is attached to a loose cover that can be replaced. Since the less expensive element will be replaced in this case, it will be more cost-efficient to attach the more expensive switching element to the central safety bracket. In this case, it is also guaranteed that the machine can only be put into operation when the replaceable cover has been installed.

According to an embodiment, the machine is a cold-glue unit, the cold-glue unit comprising a removable protective mask for a label container and at least one inspection door. The operating element for the central safety switch can be attached to the removable protective mask in this case. Since a change of the label format also necessitates a change of the protective mask, the expensive safety switch need not be exchanged together therewith.

Alternatively, the central safety switch may also be attached to the removable protective mask and the operating element for the central safety switch may be attached to the central safety bracket. This will be of advantage if the label format is exchanged rarely or not at all, since servicing of the safety switch, which is a crucial safety element, will be facilitated in this way.

According to an embodiment, the cold-glue unit comprises a gluing roller, a drive motor for the gluing roller and a lever for positioning the drive motor at an inspection position and at an operating position. For removing the gluing roller, it will be of advantage to displace the motor to a raised position. This is accomplished in a simple manner by means of a lever with which the motor is vertically adjusted via a system of rods.

This adjustment must be prevented when the unit is running. Vice versa, putting the unit into operation should only be allowed when the drive motor for the gluing roller is at the lower position, i.e. the operating position. This is accomplished in that the central safety bracket is configured such that the central safety bracket blocks the lever when the drive motor is at the operating position, so that the drive motor cannot be moved to an inspection position when the central safety bracket is closed. Vice versa, the central safety bracket may also be configured such that the drive motor blocks the central safety bracket when the drive motor is at the inspection position, so that the central safety bracket cannot be closed and so that the central safety switch can, consequently, not trigger a contact.

The above-mentioned special object of the present invention is achieved by a protection mechanism for a cold-glue unit comprising a gluing roller, a vertically adjustable drive motor for the gluing roller, a lever for raising the drive motor to an inspection position, at least one door as an inspection access and a removable protective mask for a label container, the protection mechanism being provided for monitoring and securing the position of the doors, the protective mask and the vertically adjustable drive motor for the gluing roller and comprising the following components:

a central safety bracket, which is movably supported relative to the doors, the protective mask and the vertically adjustable drive motor and configured such that it can only be closed when all the doors are closed and the vertically adjustable drive motor is at an operating position, and a central safety switch, which monitors the position of the central safety bracket and the presence of the protective mask.

A plurality of protective doors, a protective mask for the label container and the gluing-roller drive motor can thus be monitored and secured centrally by means of a safety switch making use of a small amount of hardware and wiring. Since a certain amount energy is required for manually adjusting the central safety bracket, several seconds will elapse until a door can be opened, so that, after triggering of the safety switch, there will be enough time for bringing the rotating and moving parts in the interior of the unit to a standstill gently and with little wear.

In the following, embodiments, further developments, advantages and possibilities of use of the present invention will be explained in more detail on the basis of the figures enclosed. All the features described and/or illustrated, individually or in any combination, are generally subject of the invention, regardless of their combination in the claims or the references to preceding claims. In addition, the content of the claims is made a part of the description. In the figures,

### BRIEF DESCRIPTION OF THE SEVERAL VIEWS OF THE DRAWINGS

FIG. 1 shows a schematic three-dimensional view of a cold-glue unit according to the present invention in a first operating condition;

FIG. 2 shows the unit according to FIG. 1 in a second operating condition, with the central safety bracket open;

FIG. 3 shows the unit according to FIG. 1 in a third operating condition, with the doors open;

FIG. 4 shows the unit according to FIG. 1 in a fourth operating condition in which the central safety bracket is blocked by a first door; and

FIG. 5 shows the unit according to FIG. 1 in a fifth operating condition in which the central safety bracket is blocked by a second door.

### DETAILED DESCRIPTION OF THE PREFERRED EMBODIMENTS

The present invention was realized for simplifying and thus improving and rendering safer the protection mechanisms of machines with fast moving and rotating components for protection against collisions with objects or operating staff. It is a central concept of the present disclosure to monitor and secure closable inspection openings and inspection positions of machine components by a central safety bracket in combination with a central safety switch. That is, in the closed condition of the safety bracket it will be impossible to open the inspection doors or to change the position of machine parts. Vice versa, the safety bracket cannot be closed and the machine cannot be started when doors are open and machine parts do not occupy their operating position.

This concept will exemplarily be described in the following description on the basis of a cold-glue unit used for applying labels to bottles and other containers. This concept of the present disclosure is, however, not limited to cases of use involving a cold-glue unit, but it may be applied to any machine comprising rotating and moving machine parts that are secured by inspection doors.

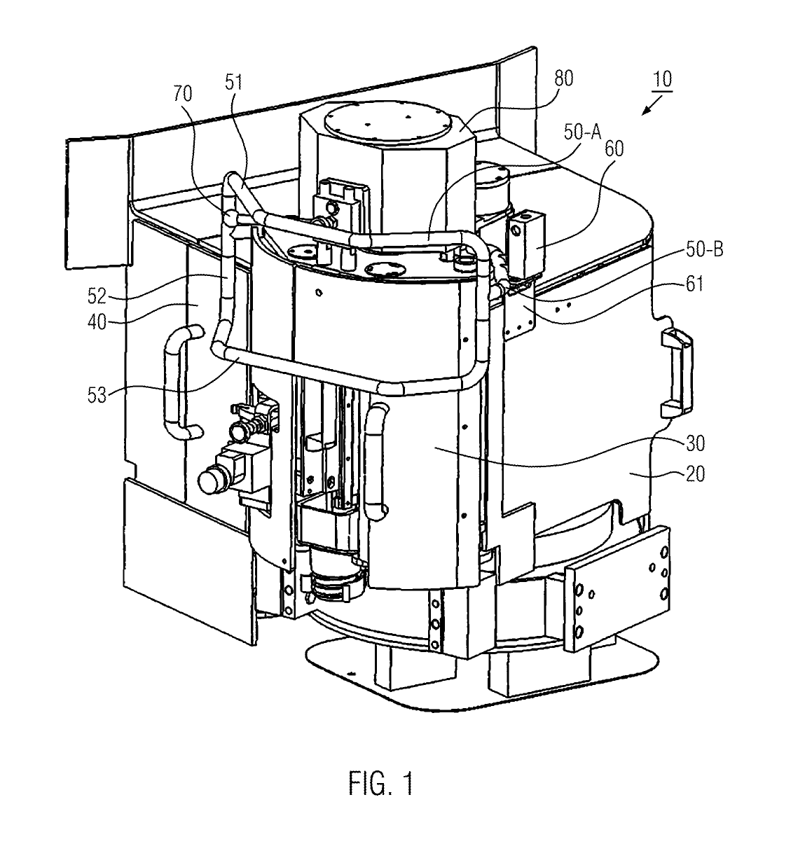

FIG. 1 shows a schematic three-dimensional view of a cold-glue unit. In such a unit, rubber-coated gluing pallets have applied thereto a very thin film of glue via a gluing roller made of hardened steel. The pallets pick up the labels from a magazine, apply a film of glue thereto and transfer them then to a gripper cylinder. The gripper cylinder places the labels with precision on the containers as they pass by on a container table. There, the labels are fixed in position and smoothed out by brushes and sponged rollers. The labeled containers are seized by a discharge star wheel and transferred to the conveyor belt.

FIG. 1 shows the labeling unit or cold-glue unit 10 with a plurality of doors 30, 40, a drive motor 80 for a gluing roller (not shown), a removable protective mask 20 for a label container (not shown), a lever 70 for vertically adjusting the drive motor 80 for the gluing roller, a central safety bracket 50-A and 50-B, a central safety switch 60 and an operating element 61 for the central safety switch 60.

FIG. 1 shows the cold-glue unit 10 in a condition in which it is ready for operation (first operating condition) and in which all the doors 30 and 40 are closed, the protective mask 20 for the label container has been installed, the drive motor 80 for the gluing roller has been lowered, the central safety bracket 50-A has been closed and the operating element 61 activates the central safety switch 60. In FIG. 1, the protective mask 20 is shown only schematically without the label container. The protective mask 20 is, however, normally provided with label format-dependent openings (not shown), i.e. a change of label format will also necessitate a change of the protective mask 20. Being the most reasonably priced part of the central switching unit, the operating element 61 for the central safety switch 60 is therefore secured to the protective mask and the central safety switch is secured to the central safety bracket. The rubber-coated gluing pallets (not visible in FIG. 1) are located behind the protective mask 20, said rubber-coated gluing pallets picking up the labels from the magazine, applying a film of glue thereto and transferring them to a gripper cylinder (not visible). Previously, the gluing pallets had applied thereto a thin film of glue via a gluing roller (not visible). The gluing roller is located behind inspection door 30. The component located behind inspection door 40 may e.g. be the gripper (not visible). The central safety bracket consists of an element 50-A for blocking and unblocking the doors 30 and 40 and the motor 80 and the lever 70, respectively, and of a fastening section 50-B through which the blocking element 50-A is movably supported. The fastening section 50-B has attached thereto the central safety switch 60 such that it is located above the protective mask 20 so that the operating element 61, which is attached to the protective mask 20, will be able to engage the central safety switch 60 and trigger a contact. The blocking element 50-A is configured such that respective sections of the blocking element 50-A block the doors 30 and 40 and the lever 70, respectively. For example, section 51 of the blocking element 50-A blocks the lever 70, so that said lever 70 cannot raise the motor 80 when the central safety bracket is closed. Likewise, section 53 of the blocking element 50-A blocks the door 30 and section 52 of the blocking element 50-A blocks the door 40, so that it cannot be opened during operation.

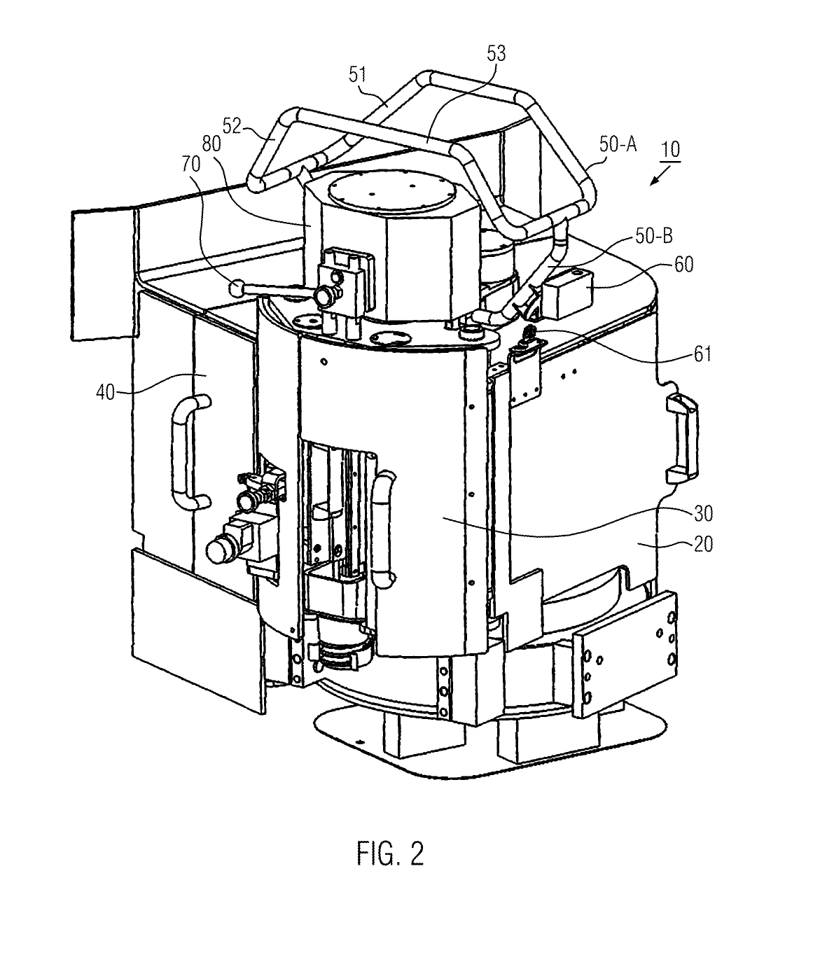

FIG. 2 shows the cold-glue unit 10 in a second operating condition, in which the central safety bracket is opened, thus unblocking the doors 30 and 40 as well as the lever 70 for raising the motor 80. In FIG. 2, elements which are identical to the elements in FIG. 1 are identified by the same reference numerals. As regards the explanation of such elements, reference is made to FIG. 1. When the central safety bracket is raised to the open position, the central safety switch 60 gets detached from the operating element 61 thus releasing also the protective mask 20. The contact in the central safety switch 60 is thus interrupted and the rotating parts in the interior of the cold-glue unit are gently decelerated. Since actuating the central safety bracket 50-A and 50-B takes one to two seconds, there is enough time for gently decelerating the moving parts, so that the doors 30 and 40 can be opened safely without any risk of injury and the motor 80 can be raised without damage being caused to the unit. The fact that the operating element 61 is secured to the protective mask 20 guarantees that installation of the protective mask 20 will not be forgotten when a change of format of the labels takes place.

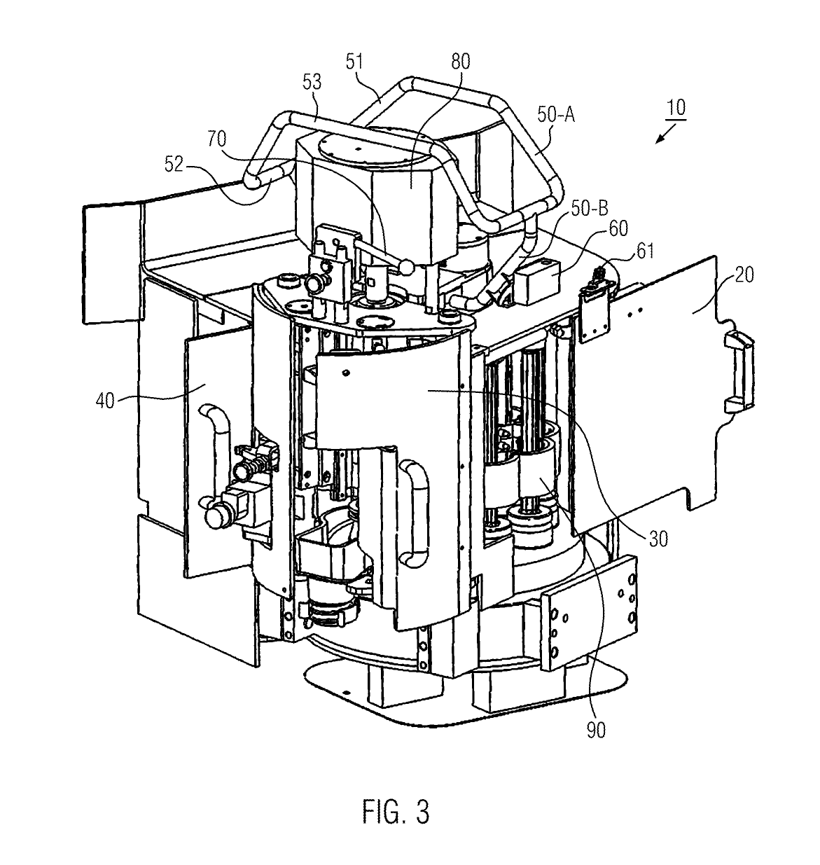

FIG. 3 shows the cold-glue unit 10 according to FIG. 1 in a third operating condition, in which the doors 30 and 40 are open, the protective mask 20 has been removed and the motor 80 raised by turning the lever 70. Also in FIG. 3, elements which are identical to the elements in FIG. 1 are identified by the same reference numerals. As regards the explanation of such elements, reference is made to FIG. 1. The third operating condition according to FIG. 3 is reached after operating condition 2 according to FIG. 2, i.e. the central safety bracket 50-A and 50-B is first moved to the open position and, subsequently, the doors 30 and 40 are opened, the motor 80 is raised and the protective mask 20 is removed. When the protective mask 20 has been removed, the gluing pallets 90 become visible. Since the contact of the central safety switch is interrupted, when the central safety bracket 50-A and 50-B is opened, the rotating components, such as the gluing pallets 90 and the gluing roller (not shown), have already come to a standstill and safe servicing with a low risk of injuries is thus possible. FIG. 3 also shows that, in the raised condition of the motor 80, the central safety bracket 50-A and 50-B cannot be closed, since the motor 80 blocks section 53 of the blocking element 50-A, so that the central safety switch 60 cannot be operated, when the mask 20 has been installed and the motor 80 raised. It can also be seen from FIG. 3 that, when the protective mask 20 has been removed, the central safety switch 60 cannot trigger a contact, even if the motor 80 were not raised and would occupy its operating position, since no operating element 61 would be able to engage the central safety switch 60 for triggering the contact.

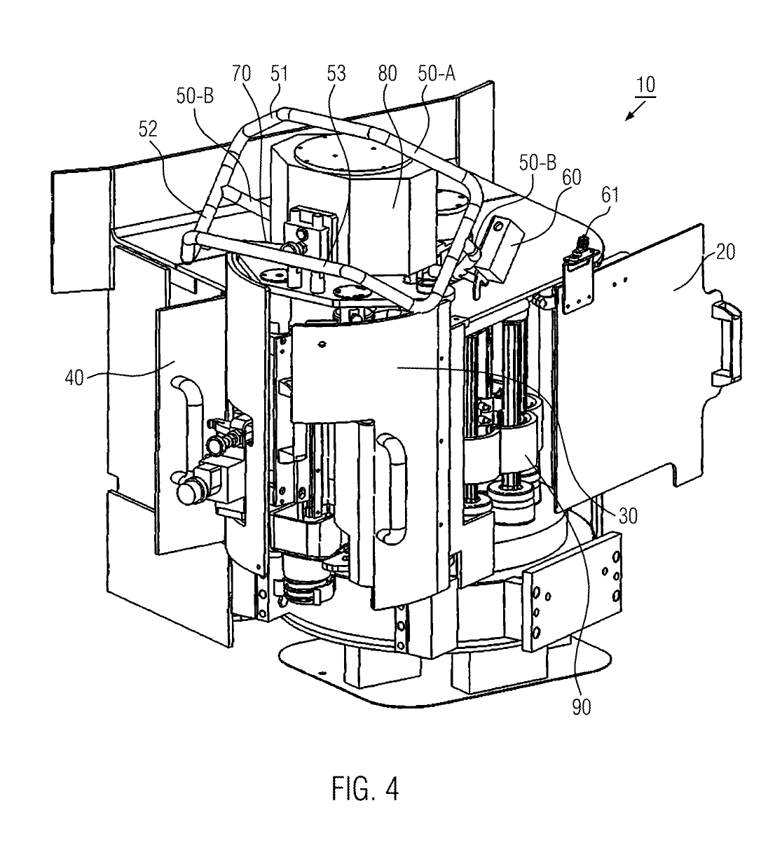

FIG. 4 shows the cold-glue unit 10 in a fourth operating condition, in which an attempt is made to close the central safety bracket 50-A and 50-B with the motor 80 lowered and the doors 30 and 40 opened. In this case, the door 30 blocks section 54 of the blocking element 50-A of the central safety bracket, so that the central safety bracket cannot be closed and the central safety switch 60 cannot establish a contact, even if the protective mask 20 is installed and the operating element 61 would be able to engage the central safety switch 60.

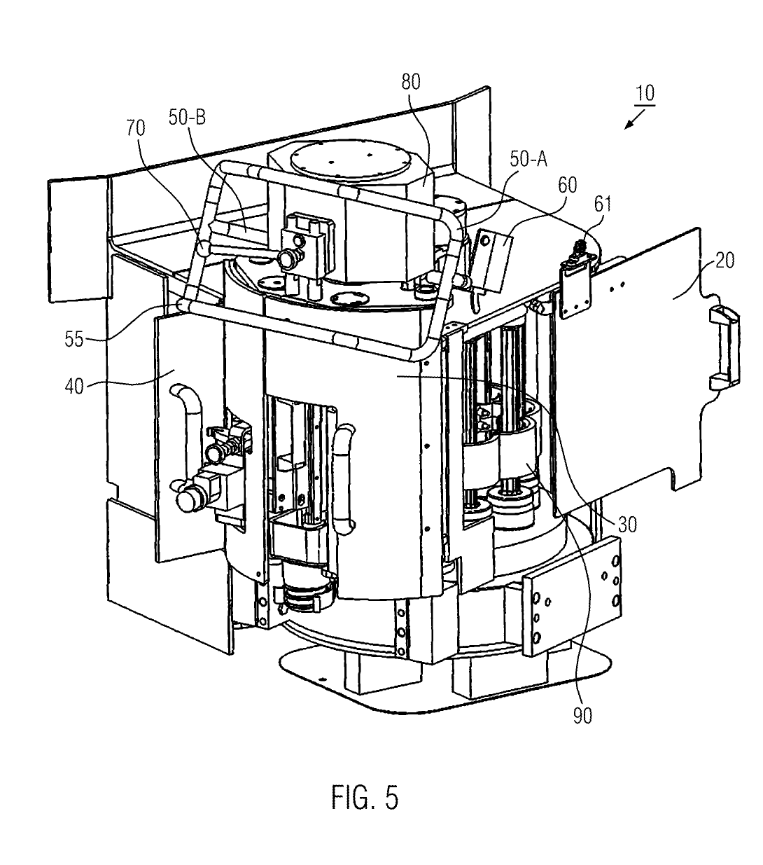

FIG. 5 shows the cold-glue unit 10 according to FIG. 1 in a fifth operating condition. As can be seen from FIG. 5, the blocking element 50-A is configured such that, when the door 30 is closed, the safety bracket is blocked via a section 55 on the blocking element 50-A, so that the central safety bracket cannot be closed. The central safety bracket is therefore configured such that it can only be moved to the closed position when all doors 30 and 40 have been closed and when the motor 80 has been lowered to an operating position. In addition, triggering a contact in the central safety switch 60 will only be possible when the central safety bracket occupies the closed position and when the protective mask 20 has been installed. Operating the cold-glue unit in an open condition is therefore impossible and safety can be guaranteed.

FIGS. 1, 2, 3, 4 and 5 show a sequence of operating conditions occurring one after the other. FIG. 1 shows a ready-to-operate condition (first operating condition). FIG. 2 shows a second operating condition in which the central safety bracket 50-A and 50-B has been opened and the contact in the central safety switch 60 interrupted, so that the moving machine parts in the unit are brought to a standstill. FIG. 3 shows an operating condition in which all the doors 30 and 40 are open, the motor 80 has been raised and the protective mask 20 removed. FIG. 4 shows a fourth operating condition in which the motor 80 has been lowered again, e.g. after servicing, and an attempt is made to close the central safety bracket, which, however, is blocked by the door 30 and cannot be closed (not yet ready for operation). FIG. 5 shows a fifth operating condition, a bit later on, in which door 30 has been closed, but door 40 is still open. When door 40 is closed and the protective mask 20 installed, the central safety bracket 50-A and 50-B can be closed, so that the operating element 61 can engage the central safety switch 60 thus triggering a contact. In this case, the first operating condition according to FIG. 1 is re-established.

What is claimed is:

1. A protection mechanism for a machine, used for monitoring and securing the position of at least one of a group including one or more doors and one or more positionable machine parts comprising:
a central safety bracket, which is movably supported relative to the at least one of the group of doors and the positionable machine parts, the central safety bracket configured such that it can only be closed when all the doors are closed and all the machine parts (80) are at an operating position, and
a central safety switch, which monitors the position of the central safety bracket.

2. The protection mechanism according to claim 1, wherein the central safety bracket is configured such that it is able to assume two end positions for the machine conditions, an open end position and a closed end position.

3. The protection mechanism according to claim 2, wherein the central safety bracket is fixed at the two end positions by means of a gas spring.

4. The protection mechanism according to claim 2, wherein the central safety bracket is configured such that, with at least one of the doors open, the central safety bracket is blocked and cannot be moved to the closed end position.

5. The protection mechanism according to claim 2, wherein the central safety bracket is configured such that the doors are blocked by the central safety bracket when the central safety bracket is at the closed end position.

6. The protection mechanism according to claim 2, wherein the central safety switch is configured such that, when actuated by an operating element for the central safety switch, it allows the machine is allowed to operate, and
when not actuated, operation of the machine is prevented.

7. The protection mechanism according to claim 1, wherein the central safety switch is attached to the central safety bracket.

8. The protection mechanism according to claim 1, wherein the machine is a cold-glue unit.

9. The protection mechanism according to claim 1, wherein the cold-glue unit comprises a removable protective mask for a label container and at least one inspection door.

10. The protection mechanism according to claim 9, wherein the operating element for the central safety switch is attached to the removable protective mask.

11. The protection mechanism according to claim 9, wherein the central safety switch is attached to the removable protective mask and the operating element for the central safety switch is attached to the central safety bracket.

12. The protection mechanism according to claim 8, wherein the cold-glue unit comprises a gluing roller, a drive motor for the gluing roller and a lever for positioning the drive motor at an inspection position and at an operating position.

13. The protection mechanism according to claim 12, wherein the central safety bracket is configured such that the central safety bracket blocks the lever when the drive motor is at the operating position, so that the drive motor cannot be moved to an inspection position.

14. The protection mechanism according to claim 12, wherein the central safety bracket is configured such that the drive motor blocks the central safety bracket when the drive motor is at the inspection position, so that the central safety bracket cannot be closed.

15. A protection mechanism for a cold-glue unit comprising a gluing roller, a vertically adjustable drive motor for the gluing roller, a lever for raising the drive motor to an inspection position, at least one door as an inspection access and a removable protective mask for a label container, the protection mechanism being provided for monitoring and securing the position of the doors, the protective mask and the vertically adjustable drive motor for the gluing roller and comprising the following components:
a central safety bracket, which is movably supported relative to the doors, the protective mask and the vertically adjustable drive motor and configured such that it can only be closed when all the doors are closed and the vertically adjustable drive motor is at an operating position, and
a central safety switch, which monitors the position of the central safety bracket, and the presence of the protective mask.
